(19) United States
(12) Patent Application Publication
(10) Pub. No.: US 2025/0162442 A1
(43) Pub. Date: May 22, 2025

(54) METHOD AND AN APPARATUS FOR MANAGING CHARGING TRANSACTIONS AND LOADS AT CHARGING STATIONS

(71) Applicant: LIIKENNEVIRTA OY / VIRTA LTD, Helsinki (FI)

(72) Inventors: Apollinariia GAINULENKO, Espoo (FI); Jani HENRIKSSON, Espoo (FI)

(73) Assignee: LIIKENNEVIRTA OY / VIRTA LTD, Espoo (FI)

(21) Appl. No.: 18/875,080

(22) PCT Filed: Jun. 9, 2023
(86) PCT No.: PCT/FI2023/050341

§ 371 Date: Dec. 13, 2024

(30) Foreign Application Priority Data
Jun. 17, 2022 (FI) 20225543

(51) Int. Cl. B60L 53/63; B60L 53/67; B60L 53/68

(52) U.S. Cl. CPC B60L 53/63; B60L 53/67; B60L 53/68

(57) ABSTRACT

According to an embodiment, charging of electric vehicles is optimized by pausing charging transactions at one or more charging points and setting them in queue based on various parameters and priorities. Further, a maximum current for charging may be changed during an ongoing charging transaction. The optimization may be deployed remotely by a computing device. Computing devices, methods, and computer programs are disclosed.

### TECHNICAL FIELD

The present application generally relates to electric vehicle charging stations. In particular, some example embodiments of the present application relate to suspending charging transactions at one or more charging stations based on one or more parameters and priorities.

### BACKGROUND

Charging stations may be subjected to load management services, which are used to adjust the total charging current the charging stations on-site cannot exceed. The total charging current may be limited, for example, due to grid connection limitation, peak shaving, peak shifting or demand-side management. However, as the number of electric vehicles increases and electric grids are under transformation due to more volatile production and increasing loads, there exists a need for more flexible charging management from both the electric grid and a user point of view.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments may enable suspending active charging transactions by prioritizing some charging transactions over others based on one or more parameters and a set minimum charging current. The prioritization may be further used to determine which charging transactions are continued and in which order. Hence, varying or fixed charging capacity may be flexibly divided between charging points such that it may be ensured that each electric vehicle wishing to charge may receive a meaningful amount of power in a meaningful time.

According to a fist aspect, there is provided a method carried out by a computing device for managing charging loads of electric vehicle charging stations, the method comprising monitoring data on charging transactions obtained from the plurality of charging stations grouped into one or more load management groups; detecting a charging transaction event associated to at least charging point of the charging stations; determining if the charging transaction event causes a share of available charging capacity divided between charging points of the load management group having an active charging transaction to decrease below a predetermined minimum current value determined for each charging point of the load management group; controlling a maximum charging current of one or more charging points to pause the active charging transaction based on one or more prioritization parameters such that the predetermined minimum current value is met for the rest of the charging points; determining if the charging transaction event causes the share of the available charging capacity to increase; and controlling the maximum charging current of at least one of the charging points to re-activate the paused charging transaction based on the one or more prioritization parameters such that the predetermined minimum current is met for all the charging stations then having an active charging transaction.

In an embodiment, the one or more prioritization parameters comprise a time of arrival of an electric vehicle being charged such that the charging transaction is first paused from one or more last arrived electric vehicles and first re-activated for the first arrived electric vehicles.

In an embodiment, in addition or alternatively, the method comprises determining a user segment associated with the charging transaction based on the charging transaction data; and wherein the one or more prioritization parameters comprise the user segment such that first paused is the charging transaction associated with a lower priority user segment and re-activated first for charging transactions associated with a higher priority user segment.

In an embodiment, in addition or alternatively, the predetermined minimum current value is different for the higher and the lower priority user segments.

In an embodiment, in addition or alternatively, the predetermined minimum current value, prioritization parameters and a hierarchy of prioritization is configurable by a user.

In an embodiment, in addition or alternatively, the method further comprises monitoring changes in the available charging capacity based on obtained data indicating an amount of available local renewable energy; and wherein the one or more charging transactions are paused or re-activated based on the changed available charging capacity affecting the number of charging transactions meeting the predetermined minimum current value.

In an embodiment, in addition or alternatively, the method further comprises monitoring changes in the available charging capacity based on obtained data indicating electricity consumption of other consumers; and wherein the one or more charging transactions are paused or re-activated based on the changed available charging capacity affecting the number of charging transactions meeting the predetermined minimum current value.

In an embodiment, in addition or alternatively, the one or more prioritization parameters comprise charged energy such that charging transactions with least charged energy are prioritized; and wherein the method comprises updating the charging transactions to be prioritized after a predetermined time.

In an embodiment, in addition or alternatively, the one or more prioritization parameters comprise a battery state-of-charge, and wherein a charging transaction associated with an electric vehicle having a smallest battery state-of-charge is prioritized; and wherein the method comprises updating the charging transactions to be prioritized after a predetermined time.

In an embodiment, in addition or alternatively, the one or more prioritization parameters comprise a random subset of charging points in the load management group to be prioritized; and wherein the method comprises selecting another subset to be prioritized after a predetermined time.

In an embodiment, in addition or alternatively, the one or more prioritizing parameters comprise at least one of a planned time of departure or a desired state-of-charge of the electric vehicle obtained based on a user input, and wherein the charging transactions associated with at least one of an electric vehicle planning to leave first or needing the biggest amount of energy are last paused and first re-activated.

In an embodiment, in addition or alternatively, when the charging transaction is associated with more than one load management groups, and wherein the maximum charging current for that charging transaction is controlled based on a lowest determined value.

According to a second aspect, there is provided a computing device, configured to monitor data on charging transactions obtained from a plurality of charging stations grouped into one or more load management groups; detect a charging transaction event from at least charging point of the charging stations; determine if the charging transaction event causes a share of available charging capacity divided between charging points of the group having an active charging transaction to decrease below a predetermined minimum current value determined for each charging point of the group; control a maximum charging current of one or more charging points to pause the active charging transaction based on one or more prioritization parameters such that the predetermined minimum current value is met for the rest of the charging points; determine if the charging transaction event causes the share of the available charging capacity to increase; and control the maximum charging current of at least one of the charging points to activate the paused charging transaction based on the one or more prioritization parameters such that the pre-determined minimum current is met for all the charging stations then having an active charging transaction.

In an embodiment, the computing device may be configured to perform any embodiment according the first aspect.

According to a third aspect, computer-readable medium comprising instructions which, when executed by a computer, cause the computer to carry out the method of the first aspect.

According to a fourth aspect, a computer program product comprising instructions which, when the program is executed by a computer, cause the computer to carry out the method of the first aspect.

Many of the attendant features will be more readily appreciated as they become better understood by reference to the following detailed description considered in connection with the accompanying drawings.

### BRIEF DESCRIPTION OF THE DRAWINGS

The accompanying drawings, which are included to provide a further understanding of the example embodiments and constitute a part of this specification, illustrate example embodiments and together with the description help to explain the principles of the example embodiments. In the drawings:

FIG. 1 illustrates an example of a method for load management at charging stations by prioritizing charge transactions based on a time of arrival according to an example embodiment;

FIG. 2 illustrates an example of a method for load management at charging stations by prioritizing one user segment over another according to an example embodiment;

FIG. 3 illustrates an example of an electricity system utilizing a method for load management of charging stations based on various parameters and priorities according to an example embodiment;

FIG. 4 illustrates a flow chart of a process for load management of charging stations according to an example embodiment;

FIG. 5 illustrates an example of a computing device configured to practise one or more example embodiments.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present examples may be constructed or utilized. The description sets forth the functions of the example and a possible sequence of operations for constructing and operating the example. However, the same or equivalent functions and sequences may be accomplished by different examples.

Charging stations (CS) are used to charge electric vehicles (EV). EV drivers own electric vehicles (EV) and charge their EVs on charging stations. Charging stations may be managed and controlled remotely by a charging point management system (CPMS) via an internet connection. Charging stations and CPMS may communicate via an OCPP protocol. Charging Stations may comprise one or more charging points (CP). A charging point may refer to any electrical energy source connection solution for the purpose of charging EVs.

As the number of EVs and charging stations are growing, so is the amount of electricity used for charging the EVs. Electric mobility is not limited just to private transportation, but it is being adopted more and more also by the public transportation. At the same time, many countries are ramping up their renewable energy production, while getting rid of the fossil fuel infrastructure. In the future, the are many more EVs that require electricity for charging their batteries. And at the same time, charging is more dependent on renewable energy sources. This brings risks and volatility into the electricity system. For example, there may be longer periods without sufficient solar or wind production, and at the same time, there may be plenty of EVs requiring energy in addition to all other electricity consumers. The demand may eventually exceed the supply. In addition to volatility from renewable resources, the electricity system is also vulnerable to global events, such as wars, natural disasters, and other events that may force countries to figure out other sources for bringing electricity to people's everyday lives.

Dynamic load management (DLM) is a common technology in EV industry to manage energy in a group of charging stations. A typical DLM solution is built in a way where multiple charging points are grouped into a single group. The group is assigned with a maximum rated current the charging points are not allowed to exceed. With centralized DLM solutions, the CPMS continuously adjusts the maximum rated current charging points can use for charging. The CPMS controls each CP individually via an API (application programming interface). Every time a DLM event takes place, the CPMS recalculates the maximum current for each CP by dividing a fixed current value between active charging points.

In general, the EV dictates the amount of power it will use for charging. Hence, a maximum limit for charging may be set to the charging point, but the EV can use less power. The amount of power the EV uses depends on a charging cycle, i.e., during start of the charge, in the middle of the charge, finishing the charge, and so on.

For example, if the limit is 64 A at site, and there are eight charging points charging simultaneously, the available charging current per CP may be 64 A/8=8 A. When there are four charging stations charging, the available current per charging station may be 64 A/4=16 A. On some DLM systems, there is also a concept of VIP-charging, which may mean that at some dedicated charging stations EV drivers get higher charging power than at other charging stations. Hence, in order to charge with a maximum current, the user needs to seek for such VIP-charging station offering the possibility to charge at the higher currents. For example, at the group of eight charging stations, charging stations 1 and 2 may always provide the full power, and charging stations 3 to 8 are for normal charging, offering less power.

Sometimes, especially on large EV charging sites, the electric infrastructure may not be able to handle a situation where all the charging points are charging simultaneously with full power. For standard load management solutions, the basic principle is the same, that is, the available charging current is evenly divided between charging points. The available charging current may depend on various factors, but in simple solutions there is a static limit for the charging power. These solutions may be referred to as dynamic load management or power sharing.

The equal share methodology may not be an ideal solution. The available charging current per active charging station may be too low. The EVs may not be able to initiate charging after a certain lower limit has been reached (usually 6 A) due to the divided capacity. If the equal share limits charging at the charging points to less than 6 A, after reaching the limit, no one would be able to charge. Hence, there is a need for a more sophisticated logic, which, after reaching the lower limit, starts pausing some charging transactions, and allowing some to charge as the divided capacity increases above the said limit for the rest of the charging stations.

For example, at office parking garages, airport parking, mall parking and housing cooperatives, there may be countless parking spaces with charging stations. Further, EV charging is desired to be enabled on as many of them as possible. The infrastructure may cause some limitations for charging, but that is rarely the case. Usually, some of the EVs are already charged, some are about to be finished charging, and some are only starting to charge. The EVs may be consuming different amount of power depending on the charging cycle. Also, some of the EVs may be full electric vehicles and some plug-in hybrids, for example. Again, they consume electric power differently.

Another factor to consider is dynamically varying charging capacity. For example, the available charging capacity may depend on building consumption, or in case of local solar production, the sun may stop shining and the site's solar panels are no longer producing additional power. In practice, at one point you might have 100 A available for charging, and at another point, you have only 50 A. On such sites, one must have a smart solution ensuring that the charging points are adjusted for available energy when needed. The solution may need to be able to react to the changes in the available capacity, in a meaningful time.

Considering the previously mentioned aspects in terms of long-term parking and charging, it is important to ensure that all the plugged-in vehicles will eventually have energy flowing into the battery while making sure the site's infrastructure is not stressed too far. An objective is therefore to ensure that all plugged-in vehicles will get to charge with a meaningful amount of power while making sure that the site's infrastructure is not stressed too far, especially at large EV charging sites with long-term charging. The solution considers various parameters affecting the available charging capacity and how to prioritize who gets to charge and when.

According to an embodiment, charging of electric vehicles is optimized by pausing charging transactions at one or more charging points and setting them in queue based on various parameters and priorities. Further, a maximum current for charging may be changed during an ongoing charging transaction. The optimization may be deployed remotely. For example, any load management adjustments may be controlled by the CPMS through cloud computing. The controlling may be implemented using, for example, OCPP protocols. Hence, the charging points do not need to be linked together physically, for example, via an Ethernet cable. The solution is compatible with any charging point that can be managed remotely. Hence, the solution is hardware-agnostic.

The method provides improved optimization and flexibility as the load management is based on different variables, such as varying charging capacity, prioritization based on transaction-related information and/or who is charging. The use of end-user information enables a queuing solution where it is possible to prioritize one or more user segments over another. For example, the VIP status for charging at higher currents may be based on the user, and not based on specific charging points. This means, that the user associated to a user segment with the VIP status could drive at any charging station to get the full power without a need to search for some dedicated charging station configured for offering the maximum current to any user. Further, the method enables to configure how much charging power a single charger has to be able to output. If there is not enough charging power available, the charging station or charging point may be put in queue. Similarly, when there is again enough charging power, the charging station/point may be released from the queue to start charging. Decisions on which order the charging stations/points are released from the queue may be based on one or more parameters, such as waiting time and/or a user segment associated with the EV waiting to start or continue charging.

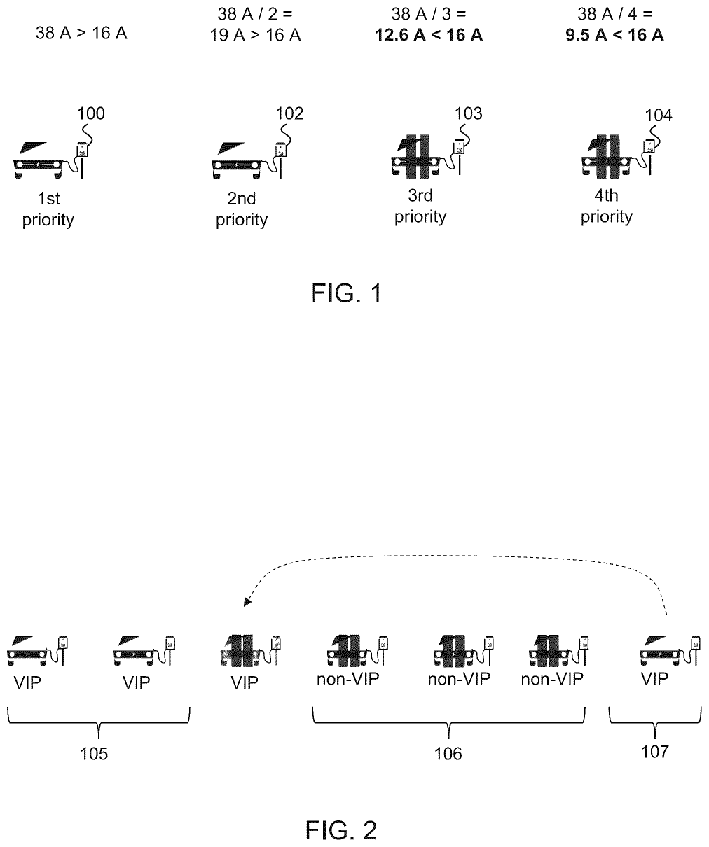

FIG. 1 illustrates an example of a method for load management at charging stations 100, 102, 103, 104 by prioritizing charge transactions based on a time of arrival, according to an example embodiment.

In an embodiment, a parameter for a minimum current may be set. The minimum current may be configured to dictate how much current each charging point may get at minimum. If the set value is not met, the next charging transactions may be set in queue until more capacity frees up from the previous charging transactions.

For example, the minimum current may be set to 6 A such that the charging points may be able to output the minimum current a vehicle needs to start the charging transaction. The minimum current may be configurable, and 6 A is only one example. This may allow a scenario where a service provider wants to allow as many simultaneous charging transactions as possible but with a limited current.

Alternatively, the minimum current may be set to match the charging stations maximum rated current. In an embodiment, the method may be configured to implement a so called first in first out logic, where the first priorities are charged as fast as possible, and others are queued for time being. This may allow the service provider to prioritize charging power and speed over the number of simultaneous charging transactions. In an embodiment, there may be a separate minimum current parameter for different user segments. Hence, the minimum current parameter enables a flexible solution and localization based on different site-specific requirements and preferences.

For example, an available charging capacity of a group of charging stations may be 38 A and the minimum current value may be set by a user to 16 A. The available charging power may be evenly distributed to charging points until there is not enough available capacity for each charging station to meet the user-defined minimum current. When minimum current per charging station drops below the defined parameter(s), the latest arrivals are paused until more capacity is released from the previously arrived charging transactions. The transactions may be prioritized based on the order of arrival. Hence, the first vehicle to start charging is the 1st priority, the second to plug in is the 2nd, and so on.

In FIG. 1, a first electric vehicle may have started charging at a first charging station 100 at a first time instance. As there is only one active charging transaction, the first charging station gets all the capacity 38 A and the minimum required current 16 A is met. At a second time instance, a second electric vehicle at a second charging station 102 initiates a charging transaction. The available charging capacity is divided between the first and the second charging stations 100, 102 (38 A/2=19 A). Hence, the minimum current value is exceeded for the charging stations (19 A>16 A). Later on, new electric vehicles arrive at a third and a fourth charging stations 103, 104 for charging. Now, after the third electric vehicle initiates a charging transaction, if the available capacity is evenly divided, the minimum current is not reached at any of the charging stations 100, 102, 103 (38 A/3=12.6 A). Hence, the third charging station 103 is put on queue until capacity is freed from the first and/or the second charging stations 100, 102. Similarly, when the fourth EV tries to start charging, the divided capacity would be 38 A/4=9.5 A which is again below the required minimum current value. Therefore, the fourth charging station is also put on queue, i.e., the charging transaction at the charging station is paused by configuring its maximum charging power to zero.

After one of the first or second priority charging stations 100, 102 are done charging, and consequently capacity for charging is freed, the third charging station 103 is next in line based on time of arrival of the third electric vehicle such that it may start charging. The fourth charging station 104 is kept in queue in case there is not enough capacity for both considering the minimum current criterion. If new electric vehicles arrived at the first or second charging stations 100, 102 for charging, they would be put in queue such that the fourth charging station 104 would now have a higher priority compared to the charging stations with later arrived electric vehicles. Hence, the queue, priorities, and paused or continued charging transactions are continuously updated based on information received from the charging stations, such as a request for charging or stop of charging and timestamps of the events.

FIG. 2 illustrates an example of a method for load management at charging stations by prioritizing one user segment over another according to an example embodiment.

In an embodiment, one user segment may be prioritized over another. EV drivers may be grouped into various user segments. For example, one user segment may comprise “VIP users” which users get more power than regular users without the VIP status. Some user segment or segments may be considered in the queuing solution. For example, the VIP users may avoid the queuing and get full power as long as it is possible without exceeding the site's energy limit and set minimum currents. It may be possible that the VIP users consume all the available energy, resulting in a situation where charging for all non-VIP users is paused. If all the VIP users cannot charge without exceeding the site limits, the VIP users may be also subjected to regular load management. During this time, all the non-VIP users are set to wait in the queue until more capacity frees up from the VIP users.

In FIG. 2, there may be two charging stations 105 providing power for electric vehicles associated with a prioritized user segment. For example, the users may be identified before the start of charging, and user data associated with the identified users may comprise an indication of which user segment they belong to. The two charging stations 105 may occupy charging capacity such that no more charging stations can provide charging current exceeding the minimum current limit. If there are lower priority user segment users charging, charging transactions at the corresponding charging stations 106 are paused and they are put on queue. If another high priority user segment user arrives at a charging station 107, it is also put in queue because the minimum current limit would not exceed if the available capacity was divided between the three charging stations 105, 107. However, after capacity is freed from at least one of the charging stations 105, the charging station 107 with a higher user segment user is prioritized over the other charging stations in queue 106 even though the other charging stations 106 would have been longer waiting in the queue. After there are no longer high priority user segment users waiting, the rest of the charging stations 106 are allowed to start or continue charging in the order of waiting time when it is possible to allocate enough current for the next charging station in queue. The minimum current required for active charging transaction may be different for the higher priority, or VIP, user segment and for the lower priority user segment without the VIP-status. For example, the minimum current value for the higher priority user segment may correspond to full power, and for lower priority user segments the minimum current value may be much lower.

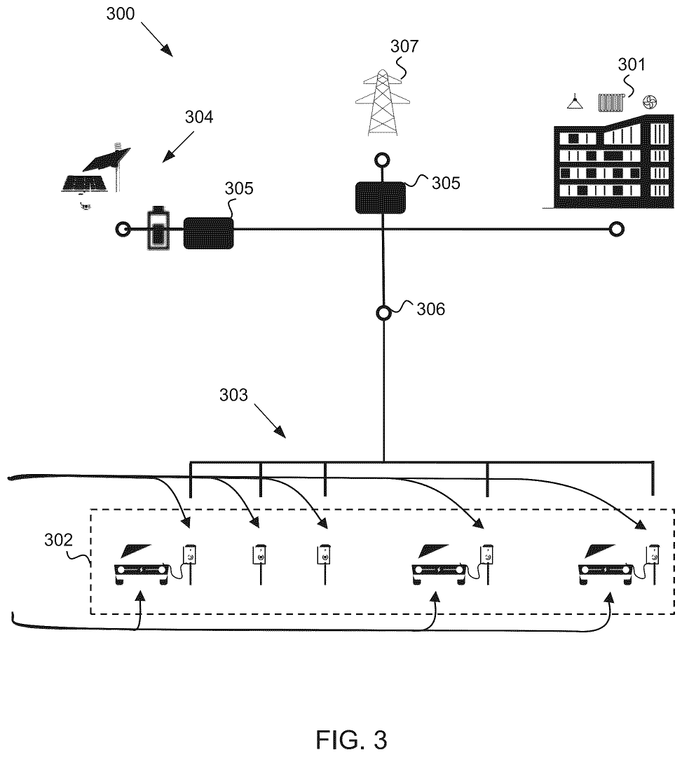

FIG. 3 illustrates an example of an electricity system 300 utilizing a method for load management of charging stations based on various parameters and priorities according to an example embodiment. Advantageously, the decisions on which EV gets to charge and which EV is set in queue may be based on varying charging capacity and other transaction-related data. The prioritizations may be charging energy management group 302 specific.

In addition to the capacity provided by the grid 307, varying local production and consumption may affect the available capacity. In an embodiment, building consumption 301 may be prioritized over charging consumption 303. Hence, when a demand at the building increases, the charging loads are decreased to avoid exceeding the site's limits. The site may be equipped with an additional measuring device for the purpose. Additionally, locally produced electricity 304 may be utilized for charging. Hence, there may be more power to be used for charging when there is locally produced electricity available. Data on the local production and consumption may be obtained, for example, from energy meters 305.

The method is also compatible with cases, where the charging capacity is stable, i.e., having a single static limit. The static limit may be based on, for example, a fuse size on a distribution board 306.

The other transaction-related data may comprise, for example, prioritization based on charged kilowatt-hours. Transactions with least charged energy may be prioritized, for example. After a predetermined time, the situation may be re-checked such that the charging points with least charged energy for the charging transaction are then prioritized.

In addition, or alternatively, the prioritization may be based on data the charging stations can provide, such as battery SoC (state-of-charge). For example, transactions with smallest SoC may be prioritized. After the predetermined time, the situation may be re-checked to pause and/or continue the charging transaction at charging points now having the smalles SoC.

In addition, or alternatively, priorities may be switched. For example, a subset of charging points may be chosen and allowed to charge and leave others queuing. After the predetermined time, another subset may be selected and allowed them to charge while the others are set to wait for their turn. The priorities may be switched after the predetermined time until at least some of the EVs are fully charged.

In addition, or alternatively, the prioritization may be based on user inputs. The user inputs may comprise, for example, a planned departure time and desired SoC. The charging transactions may be prioritized depending on which EV is planning to leave the earliest and/or which EV needs to charge the most energy.

In addition, or alternatively, the prioritization may be based on user-related information, such as the previously mentioned user segments. The different prioritization parameters may be hierarchical. For example, the user segment may be prioritized over the amount of charged power such that the higher priority users are always prioritized, and the charging transactions to be paused or continued are decided according to the charged powers.

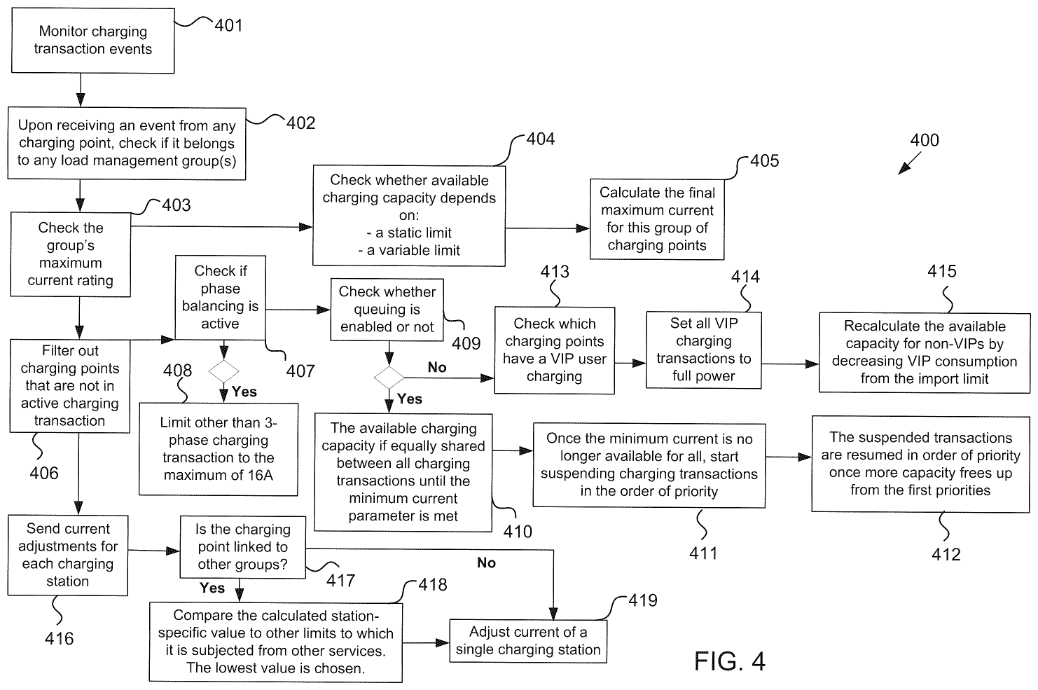

FIG. 4 illustrates a flow chart of a method 400 for load management of charging stations according to an example embodiment. The method may be implemented by a computing device communicatively coupled with a plurality of charging stations. The computing device may be configured to obtain transaction related data from the charging stations. The computing device may be further configured to control at least maximum currents of the charging stations.

At 401, charging transaction events may be monitored. A charging transaction may start once a user starts charging on a charging point and successfully authenticates oneself. Once charging starts, the charging point may change its status from “Available” to “Charging”, for example. In addition, there can be other status changes within the charging transaction. For example, once a vehicle is fully charged and doesn't take in anymore energy, the charging point may change its status to “SuspendedEV” or “Finishing”. Active charging transaction refers to a situation where a charging point is actually charging: it may report the status “Charging” and energy is flowing into the electric vehicle. Once the user selects to stop charging or unplugs the EV, the charging transaction may end. The charging transaction events may comprise, for example, a request for charging, a start of charging, an amount of charged energy, time of charging and a stop of charging. The charging transaction event may further comprise user-related data, such as data indicative of to which user segment the user requested for charging belongs to.

At 402, upon receiving an event from any charging point, it may be checked if the charging point belongs to one or more load management groups. The load management groups may be configurable. For example, electric charging points or stations may be added or removed from the group(s).

At 403, it may be checked what is the group's maximum current rating. The maximum current rating may be based on, for example, a fuse size. At 404, it may be checked whether available charging capacity depends on a static limit or a variable limit. At 405, the maximum current for the group may be updated. For example, the maximum current may be decreased or increased based on consumption of related buildings and other entities or local energy production.

At 406, charging points that are not in active charging transaction may be filtered out as they may not require charging current.

In an embodiment, the solution may be configured to meet local regulations and/or prohibitions. For example, at 407, it may be checked if phase balancing is active. If yes, at 408, a limitation may be set such that the maximum current may not be set for other than three-phase charging transactions higher than 16 A, for example, even if the calculated available capacity would be higher than 16 A.

At 409, it may be checked whether queuing is enabled or not. If yes, at 410, pausing of one or more charging transactions may take place when a certain parameter, minimum current, is not met. If the minimum current is met, the load management solution may follow a normal sharing logic. The sharing logic may be, for example, the equal share, round robin, or any other set logic. In practice, pausing the transaction may comprise setting a maximum current of a charging point to 0 A. Once the minimum current is no longer available for each charging point, suspending charging transactions in a predetermined order of priority may be started.

At 412, the suspended transactions may be resumed, i.e. re-activated, in the order of priority once more capacity frees up from the first priorities.

If the queuing is not enabled, it may be checked which charging points have a prioritized user charging, at 413. For example, users may be authenticated by the computing device to initiate/activate the charging transaction. The computing device may store data on user segments and check based on the authentication data to which user segment the user belongs to. At 414, charging transactions of all the prioritized users may be set to full power, or any other value for which they are privileged to. Thereafter, at 415, the available capacity for the non-prioritized users may be recalculated by decreasing consumption of the prioritized users from the import limit. In an embodiment, operations 413-415 may be combined with queuing such that charging transactions are suspended once the minimum current is no longer available for all, wherein the charging transactions are first suspended from the non-prioritized users.

At 416, current adjustments may be sent for each charging station. In an embodiment, a single charging point may be connected to more than one energy management groups, and requests may be prioritized from the different groups. First, at 417, it may be checked if the charging point is linked to other groups. If yes, the calculated station-specific value may be compared to other limits to which it is subjected from other energy management services, and the lowest value may be chosen at 418. The other energy management services may comprise, for example, congestion management. At 419, current of a single charging station may be adjusted based on the previously determined conditions and decisions.

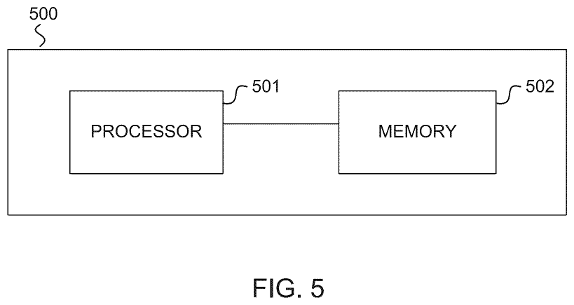

FIG. 5 illustrates an example of a computing device 500 configured to practise one or more example embodiments.

The computing device 500 may comprise at least one processor 501. The at least one processor 501 may comprise, for example, one or more of various processing devices, such as for example a co-processor, a micro-processor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The computing device 500 may further comprise at least one memory 502. The memory 502 may be configured to store, for example, computer program code or the like, for example operating system software and application software. In an embodiment, the memory 502 may comprise charging capacity data, EV charging station data and/or user-related data obtained, for example, from charging stations, user devices and/or electric meters. The memory 502 may be configured to store information about user segments comprising a list of users with different levels of priorities. The memory 502 may store one or more charging load management groups comprising one or more charging stations and/or charging points. The memory 502 may comprise one or more volatile memory devices, one or more non-volatile memory devices, and/or a combination thereof. For example, the memory may be embodied as magnetic storage devices (such as hard disk drives, magnetic tapes, etc.), optical magnetic storage devices, or semiconductor memories (such as mask ROM, PROM (programmable ROM), EPROM (erasable PROM), flash ROM, RAM (random access memory), etc.).

The computing device 500 may further comprise communication interface configured to enable computing device 500 to transmit and/or receive information, to/from other devices, such as charging stations. The computing device 500 may be configured to obtain data from multiple data sources. The data may be obtained, for example, as updates every time there has been a change in the data. The communication interface may be configured to provide at least one wireless radio connection, such as for example a 3GPP mobile broadband connection (e.g. 3G, 4G, 5G). However, the communication interface may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection such as for example a local area network (LAN) connection, a universal serial bus (USB) connection or an optical network connection, or the like; or a wired Internet connection. The communication interface may comprise, or be configured to be coupled to, at least one antenna to transmit and/or receive radio frequency signals. One or more of the various types of connections may be also implemented as separate communication interfaces, which may be coupled or configured to be coupled to a plurality of antennas.

The computing device 500 may further comprise a user interface comprising an input device and/or an output device. The input device may take various forms such a keyboard, a touch screen, or one or more embedded control buttons. The output device may for example comprise a display, or the like. In an embodiment, a user may configure a minimum current value for one or more charging load management groups and/or user segments via the user interface.

When the computing device 500 is configured to implement some functionality, some component and/or components of the computing device 500, such as for example the at least one processor 50§ and/or the memory 502, may be configured to implement this functionality. Furthermore, when the at least one processor 501 is configured to implement some functionality, this functionality may be implemented using program code comprised, for example, in the memory 502.

The functionality described herein may be performed, at least in part, by one or more computer program product components such as software components. According to an embodiment, the computing device 500 comprises a processor 501 or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), Graphics Processing Units (GPUS).

The computing device 500 may be configured to perform or cause performance of any aspect of the method(s) described herein. Further, a computer program may comprise instructions for causing, when executed, the computing device 500 to perform any aspect of the method(s) described herein. Further, the computing device 500 may comprise means for performing any aspect of the method(s) described herein. According to an example embodiment, the means comprises at least one processor 501, and memory 502 including program code, the at one memory 502 and the program code configured to, when executed by the at least one processor 501, cause performance of any aspect of the method(s).

The computing device 500 may comprise for example a server device, a client device, a mobile phone, a tablet computer, a laptop, or the like. Although the computing device 500 is illustrated as a single device it is appreciated that, wherever applicable, functions of the computing device 500 may be distributed to a plurality of devices. In an embodiment, the computing device may be or comprise a CPMS. The computing device 500 may be a cloud computing device configured to deliver computing services, such as servers, storage, databases, networking, software, analytics, and intelligence, over the Internet (“the cloud”). The computing device 500 may be located remotely from the charging stations and configured to receive and transmit data and commands wirelessly to/from the charging stations. Hence, the computing device 500 may control any charging station capable of connecting to the Internet, irrespective of differences of hardware in charging stations of different vendors or models.

It is obvious to a person skilled in the art that with the advancement of technology, the basic idea of the invention may be implemented in various ways. The invention and its embodiments are thus not limited to the examples described above, instead they may vary within the scope of the claims.

Further features of the methods directly result from the functionalities and parameters of the computer device as described in the appended claims and throughout the specification and are therefore not repeated here. It is noted that one or more operations of the method may be performed in different order.

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. A method carried out by a cloud computing device for remotely managing charging loads of a plurality of electric vehicle charging stations, the method comprising:
monitoring data on charging transactions obtained from the plurality of charging stations grouped into one or more load management groups;
detecting a charging transaction event associated to at least charging point of the charging stations;
determining if the charging transaction event causes a share of available charging current capacity between charging points of the load management group having an active charging transaction to decrease below a predetermined minimum current value determined for each charging point of the load management group, wherein the available charging current capacity has a static limit and the available charging current capacity is evenly divided between said charging points having the active charging transaction where energy is flowing into an electric vehicle;
controlling a maximum charging current of one or more charging points to pause the active charging transaction based on one or more prioritization parameters such that the predetermined minimum current value is met for the share of available charging current capacity between the rest of the charging points having the active transaction;
determining if the charging transaction event causes the share of the available charging current capacity between the charging points having the active charging transaction to increase; and
controlling the maximum charging current of at least one of the charging points to re-activate the paused charging transaction based on the one or more prioritization parameters such that the predetermined minimum current value for the share of available charging current capacity is met for all the charging stations then having an active charging transaction.

2. The method of claim 1, wherein the one or more prioritization parameters comprise a time of arrival of an electric vehicle being charged such that the charging transaction is first paused from one or more last arrived electric vehicles and first re-activated for the first arrived electric vehicles.

3. The method of claim 1, further comprising:
determining a user segment associated with the charging transaction based on the charging transaction data; and wherein the one or more prioritization parameters comprise the user segment such that first paused is the charging transaction associated with a lower priority user segment and re-activated first for charging transactions associated with a higher priority user segment.

4. The method of claim 3, wherein the predetermined minimum current value is different for the higher and the lower priority user segments.

5. The method of claim 1, wherein the predetermined minimum current value, prioritization parameters and a hierarchy of prioritization is configurable by a user.

6. The method of claim 1, further comprising:
monitoring changes in the available charging capacity based on obtained data indicating an amount of available local renewable energy; and wherein the one or more charging transactions are paused or re-activated based on the changed available charging capacity affecting the number of charging transactions meeting the predetermined minimum current value.

7. The method of claim 1, further comprising:
monitoring changes in the available charging capacity based on obtained data indicating electricity consumption of other consumers; and wherein the one or more charging transactions are paused or re-activated based on the changed available charging capacity affecting the number of charging transactions meeting the predetermined minimum current value.

8. The method of claim 1, wherein the one or more prioritization parameters comprise charged energy such that charging transactions with least charged energy are prioritized; and wherein the method comprises updating the charging transactions to be prioritized after a predetermined time.

9. The method of claim 1, wherein the one or more prioritization parameters comprise a battery state-of-charge, and wherein a charging transaction associated with an electric vehicle having a smallest battery state-of-charge is prioritized; and wherein the method comprises updating the charging transactions to be prioritized after a predetermined time.

10. The method of claim 1, wherein the one or more prioritization parameters comprise a random subset of charging points in the load management group to be prioritized; and wherein the method comprises selecting another subset to be prioritized after a predetermined time.

11. The method of claim 1, wherein the one or more prioritizing parameters comprise at least one of a planned time of departure or a desired state-of-charge of the electric vehicle obtained based on a user input, and wherein the charging transactions associated with at least one of an electric vehicle planning to leave first or needing the biggest amount of energy are last paused and first re-activated.

12. The method of claim 1, wherein when the charging transaction is associated with more than one load management groups, and wherein the maximum charging current for that charging transaction is controlled based on a lowest determined value.

13. A cloud computing device for remotely managing charging loads of a plurality of electric vehicle charging stations, configured to:
monitor data on charging transactions obtained from the plurality of charging stations grouped into one or more load management groups;
detect a charging transaction event associated to at least charging point of the charging stations;
determine if the charging transaction event causes a share of available charging current capacity between charging points of the load management group having an active charging transaction to decrease below a predetermined minimum current value determined for each charging point of the load management group, wherein the available charging current capacity has a static limit and the available charging current capacity is evenly divided between said charging points having the active charging transaction where energy is flowing into an electric vehicle;
control a maximum charging current of one or more charging points to pause the active charging transaction based on one or more prioritization parameters such that the predetermined minimum current value is met for the share of available charging current capacity between the rest of the charging points having the active transaction;
determine if the charging transaction event causes the share of the available charging current capacity between the charging points having the active charging transaction to increase; and
control the maximum charging current of at least one of the charging points to reactivate the paused charging transaction based on the one or more prioritization parameters such that the predetermined minimum current value for the share of available charging current capacity is met for all the charging stations then having an active charging transaction.

14. A computer-readable medium comprising instructions which, when executed by a computer, cause the computer to carry out the method claim 1.

15. A computer program product comprising instructions which, when the program is executed by a computer, cause the computer to carry out the method of claim 1.
